(19) United States
(12) Patent Application Publication
(10) Pub. No.: US 2020/0246749 A1
(43) Pub. Date: Aug. 6, 2020

(54) AIR PURIFYING SYSTEM

(71) Applicant: KAWASAKI JUKOGYO KABUSHIKI KAISHA, Kobe-shi, Hyogo (JP)

(72) Inventors: Katsuya UMEMOTO, Akashi-shi (JP); Teruo KISHIMOTO, Kakogawa-shi (JP); Kazuhiro OKUMURA, Kyoto-shi (JP)

(73) Assignee: KAWASAKI JUKOGYO KABUSHIKI KAISHA, Kobe-shi, Hyogo (JP)

(21) Appl. No.: 16/608,913

(22) PCT Filed: Apr. 25, 2018
(86) PCT No.: PCT/JP2018/016796

§ 371 Date: Oct. 28, 2019

(30) Foreign Application Priority Data
Apr. 27, 2017 (JP) 2017-087808

(51) Int. Cl. B01D 53/22

(52) U.S. Cl. CPC B01D 53/22

(57) ABSTRACT

An air purifying system for purifying air in a room includes: a carbon dioxide removing device including a first space and a second space that are divided from each other by a separation membrane that selectively allows carbon dioxide to permeate therethrough; a feed passage that leads the air in the room to the first space; a return passage that leads purified air from which carbon dioxide has been removed from the first space to the room; and a decompression pump that draws a vacuum in the second space, such that a carbon dioxide partial pressure in the second space is lower than a carbon dioxide partial pressure in the air in the room.

### TECHNICAL FIELD

The present invention relates to an air purifying system for purifying the air in a room.

### BACKGROUND ART

In a building, a transport vehicle, etc., a room that accommodates a person or persons requires ventilation in order to suppress increase in the carbon dioxide concentration in the room. Such a room is also provided with an air conditioner that performs heating or cooling of the room.

The amount of ventilation required for suppressing increase in the carbon dioxide concentration in the room is relatively large, which results in a high air conditioner load. In recent years, in order to lower the air conditioner load, it has been proposed to purify the air in a room by removing carbon dioxide from the air.

For example, Patent Literature 1 discloses an air purifying system installed in a railcar. In the air purifying system, a circulation passage that circulates the air in a room is provided with a carbon dioxide removing device. The carbon dioxide removing device includes a separation membrane that selectively allows carbon dioxide to permeate therethrough. Also, in order to make a pressure difference between the circulation passage side of the separation membrane (i.e., one of the spaces that are divided from each other by the separation membrane) and the permeation side of the separation membrane (the other one of the spaces that are divided from each other by the separation membrane), a decompression pump for drawing a vacuum on the permeation side of the separation membrane is connected to the carbon dioxide removing device.

### CITATION LIST

### Patent Literature

PTL 1: Japanese Laid-Open Patent Application Publication No. 2003-25991

### SUMMARY OF INVENTION

### Technical Problem

Patent Literature 1 describes that the pressure at the permeation side of the separation membrane is adjusted to about 20 kPa to make a pressure difference of about 80 kPa between the circulation passage side and the permeation side of the separation membrane, and as a result, carbon dioxide in the circulated air selectively permeates through the separation membrane.

However, when the carbon dioxide concentration in the air is 1000 ppm, the carbon dioxide partial pressure in the air is about 0.1 kPa. Thus, the pressure of 20 kPa is much higher than the carbon dioxide partial pressure in the air, and if the separation membrane selectively allows only carbon dioxide to permeate therethrough, the carbon dioxide partial pressure at the permeation side increases immediately. Consequently, the amount of carbon dioxide that permeates through the separation membrane is extremely low. Or, in order to obtain a significant carbon dioxide permeation amount, it is necessary to allow not only carbon dioxide but also a large amount of other gas components to concurrently permeate through the separation membrane so as to keep the carbon dioxide partial pressure at the permeation side low. In this case, however, electric power consumption by the decompression pump becomes excessively high.

Meanwhile, there is a different type of separation membrane that selectively allows not only carbon dioxide but also water vapor to permeate therethrough. However, even in a case where the carbon dioxide permeability and the water vapor permeability of the separation membrane are about the same, if the total pressure at the permeation side is 20 kPa, the carbon dioxide partial pressure at the permeation side is higher than the carbon dioxide partial pressure in the air. Accordingly, also in this case, the carbon dioxide partial pressure at the permeation side increases immediately. For this reason, the amount of carbon dioxide that permeates through the separation membrane is extremely low. Or, in order to obtain a practical carbon dioxide permeation amount, it is necessary to cause a large amount of air to permeate through the separation membrane together with carbon dioxide. It is impractical to adopt an apparatus having such a function. That is, in light of such a degree of vacuum as mentioned in Patent Literature 1, it is impractical to remove carbon dioxide from the air in the room.

In view of the above, an object of the present invention is to realize an air purifying system that is capable of performing efficient carbon dioxide removal by using a separation membrane and a decompression pump.

### Solution to Problem

In order to solve the above-described problems, an air purifying system according to the present invention is a system for purifying air in a room, and the air purifying system includes: a carbon dioxide removing device including a first space and a second space that are divided from each other by a separation membrane that selectively allows carbon dioxide to permeate therethrough; a feed passage that leads the air in the room to the first space; a return passage that leads purified air from which carbon dioxide has been removed from the first space to the room; and a decompression pump that draws a vacuum in the second space, such that a carbon dioxide partial pressure in the second space is lower than a carbon dioxide partial pressure in the air in the room.

According to the above configuration, the carbon dioxide partial pressure in the second space of the carbon dioxide removing device is lower than the carbon dioxide partial pressure in the first space of the carbon dioxide removing device. Accordingly, carbon dioxide selectively and continuously permeates through the separation membrane. This makes it possible to efficiently remove carbon dioxide from the air in the room.

The separation membrane may selectively allow not only carbon dioxide but also water vapor to permeate therethrough, and the decompression pump may draw a vacuum in the second space, such that a total pressure in the second space is lower than a water vapor partial pressure in the air in the room. In a case where the separation membrane selectively allows only carbon dioxide to permeate therethrough, i.e., in a case where only carbon dioxide is present in the second space, it is necessary to draw a vacuum in the second space, such that the pressure in the second space is lower than the carbon dioxide partial pressure in the first space. For example, when the carbon dioxide concentration in the air in the room is 1000 ppm, the pressure in the second space needs to be lower than 0.1 kPa. In this respect, since the amount of water vapor present in the air in the room is greater than the amount of carbon dioxide present in the air in the room, if the separation membrane selectively allows not only carbon dioxide but also water vapor to permeate therethrough, the amount of water vapor can be made greater than the amount of carbon dioxide also in the second space. Therefore, by setting the total pressure in the second space to be lower than the water vapor partial pressure in the first space, the carbon dioxide partial pressure in the second space can be suppressed from increasing, and this makes it possible to obtain a necessary carbon dioxide permeation amount with a practical apparatus scale.

The air purifying system may further include a water vapor supplying device that supplies water vapor to the second space, such that a water vapor partial pressure in the second space is substantially equal to a water vapor partial pressure in the first space. According to this configuration, water vapor is suppressed from permeating through the separation membrane from the first space to the second space. As a result, the suction amount of the decompression pump is reduced, and thereby the load on the decompression pump can be reduced.

### Advantageous Effects of Invention

The present invention makes it possible to perform efficient carbon dioxide removal by using a separation membrane and a decompression pump.

### BRIEF DESCRIPTION OF DRAWINGS

FIG. 1 shows a schematic configuration of an air purifying system according to Embodiment 1 of the present invention.

FIG. 2 shows a schematic configuration of an air purifying system according to Embodiment 2 of the present invention.

### DESCRIPTION OF EMBODIMENTS

### Embodiment 1

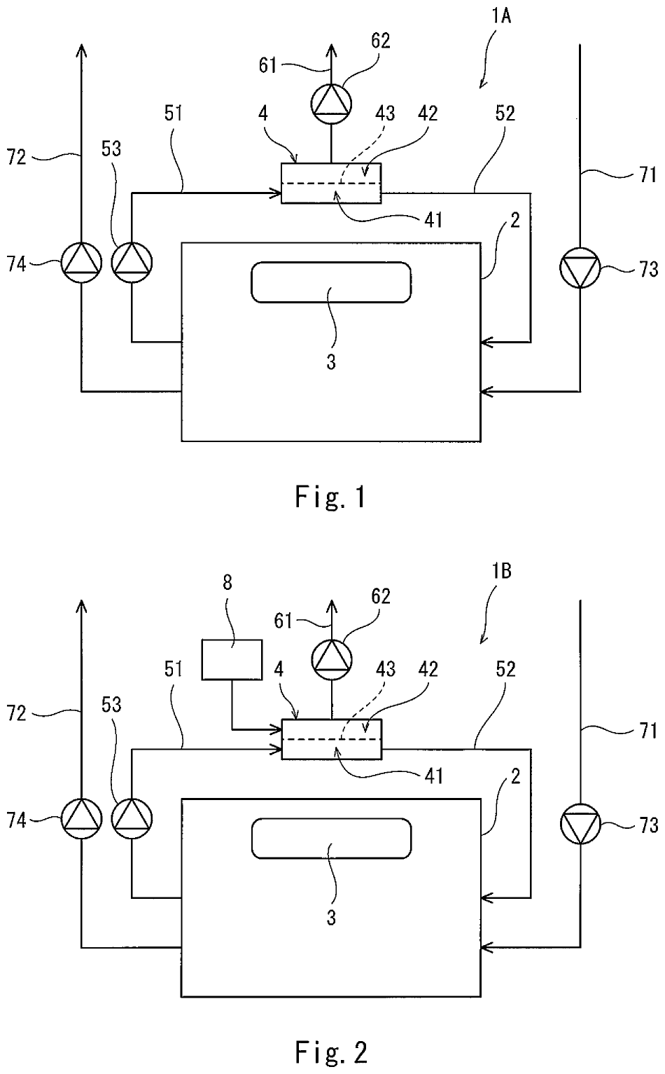

FIG. 1 shows an air purifying system 1A according to Embodiment 1 of the present invention. The air purifying system 1A purifies the air in a room 2, which accommodates a person or persons.

For example, the room 2 may be a room of a building, such as an office building, or may be a room (a cabin) of a transport vehicle, such as a railcar or an aircraft. Alternatively, the room 2 may be a room of, for example, a space station, a submersible ship, or a disaster refuge facility.

The air purifying system 1A includes a carbon dioxide removing device 4. In the illustrated example, the carbon dioxide removing device 4 is disposed outside the room 2. However, as an alternative, the carbon dioxide removing device 4 may be disposed inside the room 2.

The carbon dioxide removing device 4 includes a first space 41 and a second space 42, which are divided from each other by a separation membrane 43. The separation membrane 43 selectively allows carbon dioxide to permeate therethrough from the first space 41 to the second space 42. In the present embodiment, the separation membrane 43 selectively allows not only carbon dioxide but also water vapor to permeate therethrough.

Desirably, the carbon dioxide permeability and water vapor permeability of the separation membrane 43 are 1000 times or more as great as its nitrogen permeability and oxygen permeability. The permeability of each component through the separation membrane 43 is represented by an equation shown below.

m=K×A×ΔP, where:
m is the permeation rate [mol/sec] of a specific component;
K is the permeability [mol/(m²·sec·a)] of the specific component;
A is the area [m²] of the separation membrane; and
ΔP is a difference in the partial pressure [Pa] of the specific component between both sides of the separation membrane.

For example, the separation membrane 43 is a hollow fiber membrane. In this case, a large number of such hollow fiber membranes may constitute a single membrane module, and the carbon dioxide removing device 4 may include a large number of such membrane modules. In the case where the separation membrane 43 is a hollow fiber membrane, the inner side of the hollow fiber membrane is the first space 41, and the outer side of the hollow fiber membrane is the second space 42.

The air in the room 2 is led to the first space 41 of the carbon dioxide removing device 4 through a feed passage 51, and purified air from which carbon dioxide has been removed is led from the first space 41 to the room 2 through a return passage 52. In the present embodiment, the feed passage 51 is provided with an air feeder 53. However, instead of the feed passage 51, the return passage 52 may be provided with the air feeder 53. The air feeder 53 may be a blower or a fan (the same is true of the other air feeders mentioned below).

A suction passage 61 is connected to the second space 42 of the carbon dioxide removing device 4. The downstream end of the suction passage 61 is open in the atmosphere. The suction passage 61 is provided with a decompression pump 62.

The decompression pump 62 draws a vacuum in the second space 42, such that the carbon dioxide partial pressure in the second space 42 is lower than the carbon dioxide partial pressure in the air in the room 2. For example, assume that the temperature of the air in the room 2 is 25° C., the pressure of the air in the room 2 is the atmospheric pressure, and the carbon dioxide concentration in the air in the room 2 is 1000 ppm. In this case, the carbon dioxide partial pressure in the air in the room 2 is about 0.1 kPa. In the present embodiment, the separation membrane 43 allows not only carbon dioxide but also water vapor to permeate therethrough. Accordingly, even if the total pressure in the second space 42 is about 1.0 kPa, the carbon dioxide partial pressure in the second space 42 can be kept lower than the carbon dioxide partial pressure in the first space 41.

For example, if the total pressure in the second space 42 is 0.1 kPa, a significantly large amount of energy is required for driving the decompression pump 62. However, if the total pressure in the second space 42 is about 1.0 kPa, the amount of energy required for driving the decompression pump 62 can be reduced although the size of the carbon dioxide removing device 4 in this case is large.

In a case where the temperature of the air in the room 2 is 25° C. and the pressure of the air in the room 2 is the atmospheric pressure, when the relative humidity in the room 2 is 20%, the water vapor partial pressure in the air in the room 2 is 0.6 kPa, and when the relative humidity in the room 2 is 80%, the water vapor partial pressure in the air in the room 2 is 2.5 kPa. Accordingly, a control target value of the total pressure in the second space 42, the total pressure being controlled by the decompression pump 62, may be set to 0.5 kPa or less, for example. Alternatively, the total pressure in the second space 42 may be varied in accordance with the relative humidity in the room 2.

The room 2 is provided with an air conditioner 3, which performs heating and cooling. A first ventilation passage 71 and a second ventilation passage 72 are connected to the room 2.

The room 2 is supplied with outside air from the atmosphere through the first ventilation passage 71, and the air in the room 2 is discharged into the atmosphere through the second ventilation passage 72. The first ventilation passage 71 and the second ventilation passage 72 are provided with an air feeder 73 and an air feeder 74, respectively.

As described above, in the air purifying system 1A of the present embodiment, the carbon dioxide partial pressure in the second space 42 of the carbon dioxide removing device 4 is lower than the carbon dioxide partial pressure in the first space 41 of the carbon dioxide removing device 4. Accordingly, carbon dioxide selectively and continuously permeates through the separation membrane 43. This makes it possible to efficiently remove carbon dioxide from the air in the room 2.

Further, in the present embodiment, the separation membrane 43 selectively allows not only carbon dioxide but also water vapor to permeate therethrough. In a case where the separation membrane 43 selectively allows only carbon dioxide to permeate therethrough, i.e., in a case where only carbon dioxide is present in the second space 42, it is necessary to draw a vacuum in the second space 42, such that the pressure in the second space 42 is lower than the carbon dioxide partial pressure in the first space 41. For example, when the carbon dioxide concentration in the air in the room is 1000 ppm, the pressure in the second space 42 needs to be lower than 0.1 kPa. In this respect, since the amount of water vapor present in the air in the room is greater than the amount of carbon dioxide present in the air in the room, if the separation membrane 43 selectively allows not only carbon dioxide but also water vapor to permeate therethrough as in the present embodiment, the amount of water vapor can be made greater than the amount of carbon dioxide also in the second space 42. Therefore, by setting the total pressure in the second space 42 to be lower than the water vapor partial pressure in the first space 41, the carbon dioxide partial pressure in the second space 42 can be suppressed from increasing, and this makes it possible to obtain a necessary carbon dioxide permeation amount with a practical apparatus scale.

### Embodiment 2

FIG. 2 shows an air purifying system 1B according to Embodiment 2 of the present invention. It should be noted that, in the present embodiment, the same components as those described in Embodiment 1 are denoted by the same reference signs as those used in Embodiment 1, and repeating the same descriptions is avoided.

The air purifying system 1B of the present embodiment is a result of adding a water vapor supplying device 8 to the air purifying system 1A of Embodiment 1. The water vapor supplying device 8 supplies water vapor to the second space 42, such that the water vapor partial pressure in the second space 42 of the carbon dioxide removing device 4 and the water vapor partial pressure in the first space 41 of the carbon dioxide removing device 4 are substantially equal to each other. For example, it is desirable that the water vapor partial pressure in the second space 42 of the carbon dioxide removing device 4 be kept within the range of ±10% of the water vapor partial pressure in the first space 41 of the carbon dioxide removing device 4.

In the present embodiment, water vapor is suppressed from permeating through the separation membrane 43 from the first space 41 to the second space 42. As a result, the suction amount of the decompression pump 62 is reduced, and thereby the load on the decompression pump 62 can be reduced.

### Other Embodiments

The present invention is not limited to the above-described embodiments. Various modifications can be made without departing from the spirit of the present invention. For example, it is not essential that the room 2 be provided with the air conditioner 3.

The component that selectively permeates through the separation membrane 43 together with carbon dioxide need not be water vapor, but may be nitrogen or oxygen. That is, the separation membrane 43 may selectively allow not only carbon dioxide but also nitrogen or oxygen to permeate therethrough.

Alternatively, the separation membrane 43 may selectively allow only carbon dioxide to permeate therethrough. In this case, the decompression pump 62 is required to draw a vacuum in the second space 42, such that the pressure in the second space 42 is lower than 0.1 kPa.

### REFERENCE SIGNS LIST

1A, 1B air purifying system

2 room

4 carbon dioxide removing device

41 first space

42 second space

43 separation membrane

51 feed passage

52 return passage

62 decompression pump

8 water vapor supplying device

1. An air purifying system for purifying air in a room, the air purifying system comprising:
a carbon dioxide removing device including a first space and a second space that are divided from each other by a separation membrane that selectively allows carbon dioxide to permeate therethrough;
a feed passage that leads the air in the room to the first space;
a return passage that leads purified air from which carbon dioxide has been removed from the first space to the room; and
a decompression pump that draws a vacuum in the second space, such that a carbon dioxide partial pressure in the second space is lower than a carbon dioxide partial pressure in the air in the room.

2. The air purifying system according to claim 1, wherein
the separation membrane selectively allows not only carbon dioxide but also water vapor to permeate therethrough, and
the decompression pump draws a vacuum in the second space, such that a total pressure in the second space is lower than a water vapor partial pressure in the air in the room.

3. The air purifying system according to claim 1, wherein
the separation membrane selectively allows not only carbon dioxide but also water vapor to permeate therethrough, and
the air purifying system further comprises a water vapor supplying device that supplies water vapor to the second space, such that a water vapor partial pressure in the second space is substantially equal to a water vapor partial pressure in the first space.
